(19) United States
(12) Patent Application Publication
(10) Pub. No.: US 2004/0137213 A1
(43) Pub. Date: Jul. 15, 2004

(54) Refrigerator with a finish material containing nanosilver particles

(76) Inventor: Jin Soo Kim, Seoul (KR)

Correspondence Address: David A. Einhorn, Esq., Anderson Kill & Olick, P.C., 1251 Avenue of the Americas, New York, NY, 10020, US

(21) Appl. No.: 10/617,158

(22) Filed: Jul. 10, 2003

(30) Foreign Application Priority Data
Jan. 14, 2003 (KR) 10-2003-002291
Jan. 14, 2003 (KR) 10-2003-002292
Jan. 14, 2003 (KR) 10-2003-002293

(51) Int. Cl. B32B 5/16

(52) U.S. Cl. 428/323

(57) ABSTRACT

A refrigerator of the present invention includes a finish material constituting the refrigerator. The finish material contains antibacterial nanosilver particles. Preferably, the nanosilver particles have a size of about 15˜300 nm and a concentration of about 1˜500 ppm. The finish material may constitute any part of the refrigerator where there may be caused a generation and multiplication of bacteria. The finish material may be made from a transparent or opaque resin to which pigment is added. The nanosilver particles may be coated on a surface of the finish material.

### FIELD OF THE INVENTION

The present invention relates to a refrigerator with a finish material containing antibacterial and/or antifungal nanosilver particles; and, more particularly, to a refrigerator including a finish material which contains nanosilver particles exhibiting optimal antibacterial and/or antifungal functions by limiting the size and the concentration of the nanosilver particles to specific ranges which are practical and applicable, respectively.

### BACKGROUND OF THE INVENTION

In general, silver (Ag) is well-known as a common antibacterial agent. Colloidal silver is known as being safe and effective against bacteria, fungi, microbes, virus and the like. Particularly, when silver ions are absorbed into cells of virus, bacteria, fungi and the like, the silver ions prevent the operation of enzyme required in respiration thereof to render them dead. Further, silver ions prevent metabolism of the bacteria and suppress reproductive function thereof.

The fine particles of silver can be produced by a physical process such as electrolysis, liquid phase reduction, and grinding. The electrolysis has mainly been used hitherto in order to obtain stabilized nanosilver particles with a high purity. In the electrolysis process, pure silver (99.99%) is immersed into distilled water; and extremely fine particulates of silver are obtained by applying a low current at a low temperature.

On the other hand, a refrigerator serves to preserve food in a fresh state for a long period in a food storage compartment by cooling air in the compartment using a refrigerating cycle. In the refrigerator, refrigerant gas compressed under a high temperature and a high pressure by a compressor is condensed into liquid phase in a condenser; and the liquid is then pressure-reduced through an expansion valve and evaporated in an evaporator. At this time, the evaporating refrigerant takes heat from ambient air to cool it. The cooled air is then forced to the food storage compartment by, e.g., a fan.

It has been attempted to provide the refrigerator with an antibacterial function. However, in a conventional antibacterial agent such as silver-based zeolite inorganic antibacterial agent and silver powder antibacterial agent with micron-sized particles, the micron-sized silver particles have a specific surface area per a unit weight less than that of nano-sized silver particles; and, therefore, a greater amount of the former is needed than the latter in order to exhibit the same antibacterial ability. Further, the conventional antibacterial agent is not smoothly dispersed while being mixed with a resin since the particle size thereof is large, and is likely to cause scratches to the surface of an injection mold.

### SUMMARY OF THE INVENTION

It is, therefore, a primary object of the present invention to provide a refrigerator having a finish material containing antibacterial nanosilver particles.

It is another object of the present invention to provide a refrigerator with an appropriate antibacterial function by limiting the size and the concentration of the nanosilver particles to specific ranges which are suitable for the optimal antibacterial action, respectively, thereby increasing the satisfaction of users.

In accordance with an aspect of the present invention, there is provided a refrigerator including: a finish material constituting the refrigerator, the finish material containing nanosilver particles.

Preferably, the nanosilver particles have a size of about 15˜300 nm and a concentration of about 1˜500 ppm. More preferably, the concentration of the nanosilver particles ranges about 50˜500 ppm.

The finish material may be an interior finish material which constitutes a food storage compartment of the refrigerator.

The finish material may be formed from a transparent or opaque resin to which pigment is added.

### BRIEF DESCRIPTION OF THE DRAWINGS

The above and other objects and features of the present invention will become apparent from the following description of preferred embodiments given in conjunction with the accompanying drawings in which:

FIG. 1 is a schematic cross-sectional view of a finish material of the present invention wherein nanosilver particles are added thereto;

FIGS. 2A and 2B represent antibacterial test results of used test isolates;

FIGS. 3A and 3B show test results of MacConkey agar medium cultivation of bacterial in a tangerine in a vessel made of a finish material containing nanosilver particles in accordance with the present invention and a conventional vessel made of a finish material without nanosilver, respectively; and

FIGS. 4A and 4B show test results of MacConkey agar medium cultivation of bacterial in meat in a vessel made of a finish material containing nanosilver particles in accordance with the present invention and a conventional vessel made of a finish material without nanosilver, respectively.

### DETAILED DESCRIPTION OF THE PREFERRED EMBODIMENTS

A preferred embodiment of the present invention will now be described in detail with reference to the accompanying drawings.

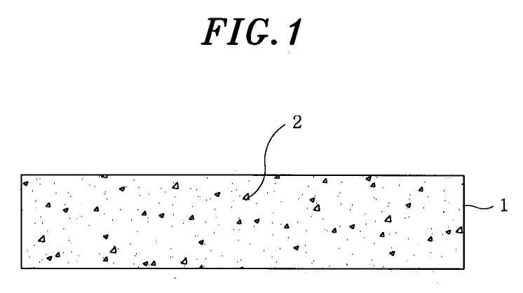

FIG. 1 is a schematic cross-sectional view of a finish material 1 of the present invention wherein nanosilver particles 2 are added thereto.

The inventor has studied for employing the nanosilver particles so as to provide a refrigerator with an antibacterial function. In other words, by incorporating nanosilver particles into a finish material constituting any part of the refrigerator where there may be caused a generation and multiplication of bacteria, such as an interior finish material constituting a food storage compartment of the refrigerator, a storage vessel, a pocket and a part constituting an air circulation duct, the finish material comes to have the antibacterial function.

As shown, the nanosilver particles 2 may be contained in the finish material 1, e.g., the interior finish material constituting the food storage compartment of the refrigerator. Alternatively, the nanosilver particles 2 may be coated on a surface of the finish material 1 of the refrigerator.

In the preferred embodiment of the present invention, the size of the nanosilver particles 2 is limited to about 15˜300 nm in consideration of the current manufacturing technique and the efficiency of specific surface area per a unit weight.

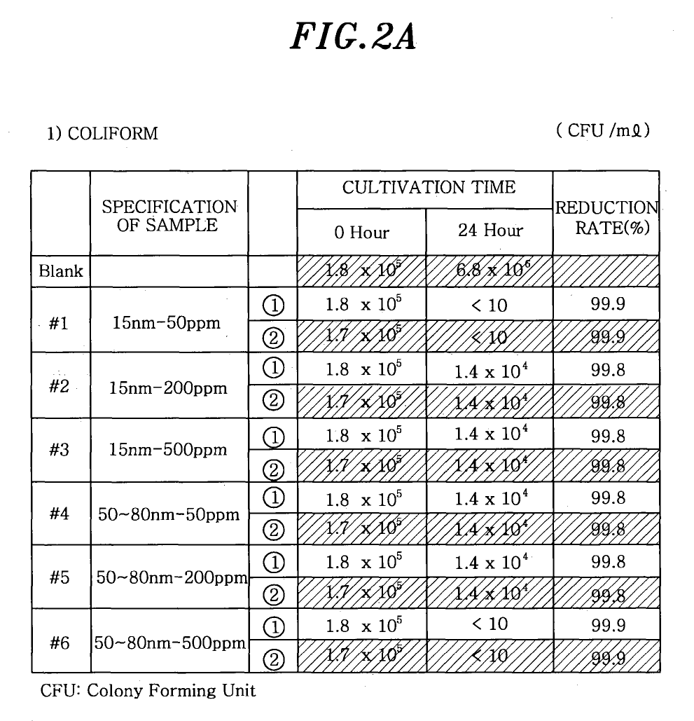

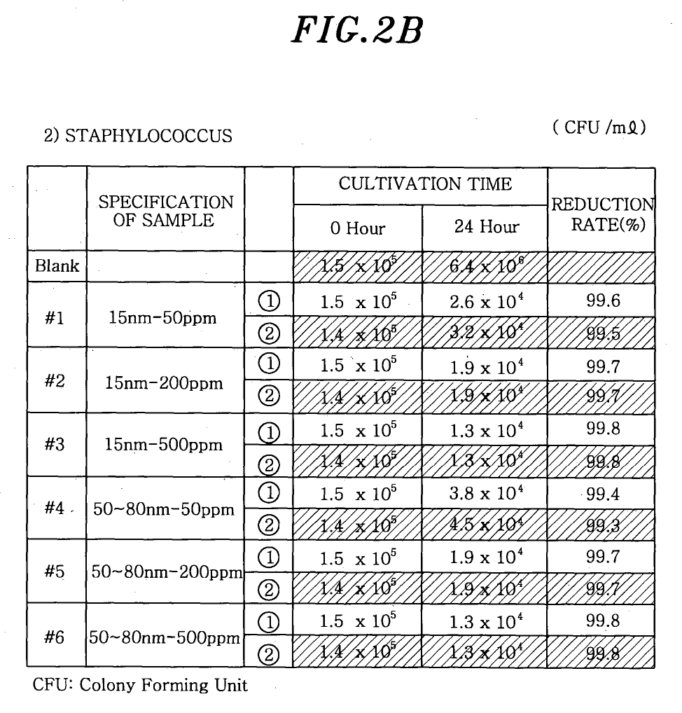

Further, the concentration of the nanosilver particles 2 added to the finish material 1 is limited to a range of about 1˜500 ppm by weight such that the expensive nanosilver can efficiently be used and a target antibacterial ability can be obtained. As the concentration of the nanosilver is increased, the antibacterial ability is raised; however, as can be seen from the test results in FIGS. 2A and 2B, in the range of 50˜500 ppm, there is no significant difference of the antibacterial ability. In addition, in the above concentration range of the nanosilver, the sterilization or bacteriostasis can be performed stably and efficiently.

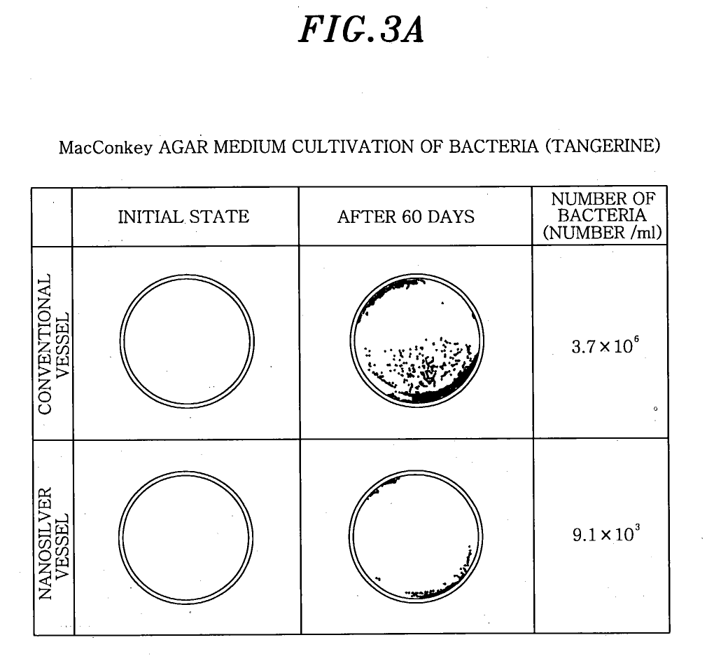

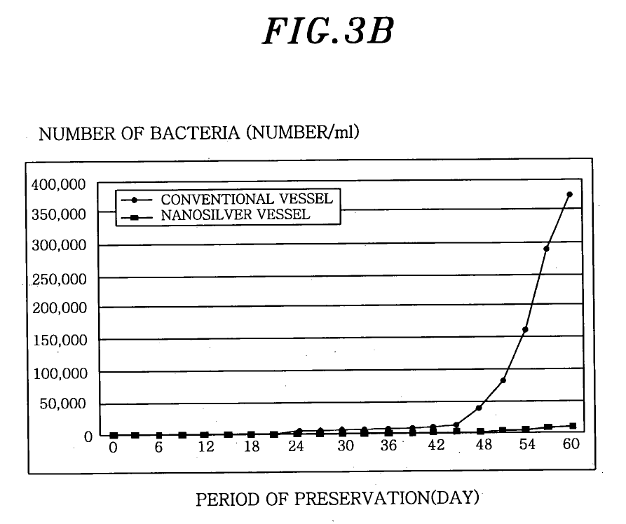

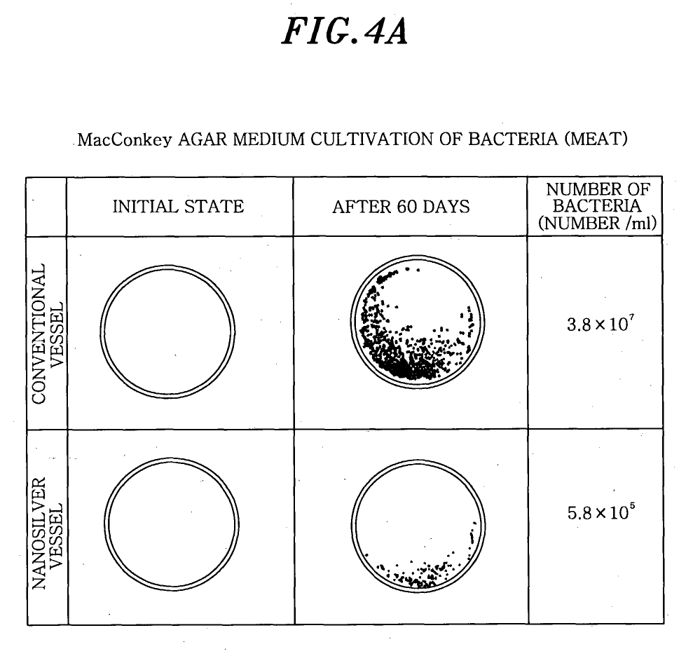

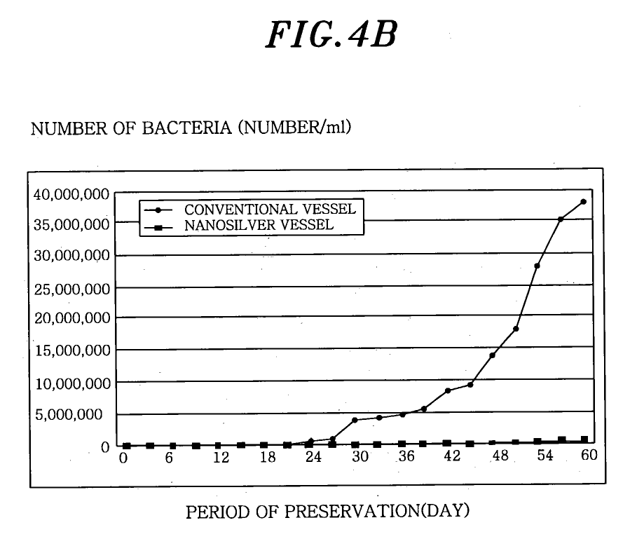

FIGS. 3A and 3B show test results of MacConkey agar medium cultivation of bacterial in a tangerine and FIGS. 4A and 4B indicate test results in meat. As can be seen from the results, the multiplications of bacteria in the tangerine and the meat are suppressed in a vessel made of the finish material containing nanosilver particles in accordance with the present invention more significantly than in a conventional vessel made of a finish material without nanosilver.

In addition, the finish material 1 may be made from a transparent or opaque resin to which pigment is added.

While the invention has been shown and described with respect to the preferred embodiments, it will be understood by those skilled in the art that various changes and modifications may be made without departing from the spirit and scope of the invention as defined in the following claims.

What is claimed is:

1. A refrigerator comprising:
a finish material constituting any part of the refrigerator, the finish material containing antibacterial nanosilver particles.

2. The refrigerator of claim 1, wherein the nanosilver particles have a size of about 15˜300 nm and a concentration of about 1˜500 ppm.

3. The refrigerator of claim 1 or 2, wherein the finish material is an interior finish material which constitutes a food storage compartment of the refrigerator.

4. The refrigerator of claim 1 or 2, wherein the finish material is made from a transparent or opaque resin to which pigment is added.

5. The refrigerator of claim 1, wherein the nanosilver particles are coated on a surface of the finish material.
